(19) United States
(12) Patent Application Publication
(10) Pub. No.: US 2004/0208724 A1
(43) Pub. Date: Oct. 21, 2004

(54) Screw element with a spring element formed thereon

(75) Inventors: Heinrich Friederich, Gross-Rohrheim (DE); Reinhard Schmoock, Netphen-Nenkersdorf (DE)

Correspondence Address: ALTERA LAW GROUP, LLC, 6500 CITY WEST PARKWAY, SUITE 100, MINNEAPOLIS, MN, 55344-7704, US

(73) Assignee: EJOB GmbH & Co KG

(21) Appl. No.: 10/827,499

(22) Filed: Apr. 19, 2004

(30) Foreign Application Priority Data
Apr. 19, 2003 (DE) 103 18 023.0

(51) Int. Cl. H01H 3/16

(52) U.S. Cl. 411/383

(57) ABSTRACT

A screw element with a tool engagement means (5, 6) and a spring element (8) which is formed on the screw element in one piece in coaxial relationship with the screw axis (7) and which with its free edge defines a workpiece contact plane which is perpendicular to the screw axis and which is at an axial spacing from the screw element (1), is distinguished in that the spring element (8) is mounted at the periphery of the screw element, that is to say a screw head (4) or a screw nut, it projects radially beyond the periphery and it forms a workpiece contact means (9) which is disposed outside the periphery and which is in concentric relationship with the screw axis (7).

The invention concerns a screw element with a tool engagement means and a spring element which is formed on the screw element in one piece in coaxial relationship with the screw axis and which with its free edge defines a workpiece contact plane which is perpendicular to the screw axis and which is at an axial spacing from the screw element.

A spring element which is disposed between a screw element which can be the head of a screw or a screw nut and the workpiece which is to be fixed serves to permanently maintain the force between the workpiece and the screw element, which is required to secure the screw connection. The spring force prevents the prestressing effect for the screw connection being lost by virtue of changes in length (thermal elongation of the screw, shrinkage of the workpieces and so forth) or prevents mechanical influences such as vibration and shaking movements resulting in the screw connection becoming unscrewed as a consequence of insufficient frictional force. In general the spring element is a separate component which, before the screw is fitted through the workpieces to be connected, is fitted on to the screw shank and placed beneath the screw head, or which, after the screw has been fitted through the workpieces, is fitted on to the outwardly projecting screw-threaded portion of the screw and is placed between a screw nut and the adjoining workpiece. It is possible in that way to use different materials with different properties, on the one hand for the screw element and on the other hand for the spring element.

It is however also known for the screw element to be produced in one piece with the spring element and in that way to ensure that the spring element is not lost or is not forgotten when the screw connection is being made. In the case of the screw nut referred to in the opening part of this specification and known from Swiss patent specification No 101 675, the spring element comprises a projection at the end face of the screw nut, which projection is of an angularly bent configuration at a plurality of locations similarly to a bellows member and which remains within the periphery of the nut and which enjoys its spring characteristic by virtue of the radial indentation configuration formed by the angular portions (resilient return effect). That design not only increases the axial structural length but also requires a relatively high level of manufacturing expenditure. In addition variations in the spring characteristic of the spring element are possible only to a very limited extent, if at all. A similar consideration applies to the arrangement known from DE 26 01 731 A1.

It is here that the invention seeks to provide a remedy. It provides that, based on the design outlined in the opening part of this specification and discussed hereinbefore, the spring element is mounted at the periphery of the screw element, that is to say a screw head or a screw nut, it projects radially beyond the periphery and it forms a workpiece contact means which is disposed outside the periphery and which is in concentric relationship with the screw axis. In that way the spring element attachment on the screw element scarcely increases the axial length thereof, more specifically only by that amount which is required for the spring travel. In addition, numerous possible design configurations are afforded for the spring element, by means of which its spring characteristic can be varied to a considerable extent, depending on the respective purpose of use and nature of the screw connection.

DE 33 27 587 A1 admittedly discloses a screw element (screw head or screw nut) in which the spring element formed thereon projects radially beyond the screw element. That however involves a conventional spiral spring ring which is fixed only over a small part of its periphery to the screw element and which in other respects is disposed separately therefrom outside its periphery. Accordingly force is transmitted only at the fixing location and thus eccentrically with respect to the screw connection. In addition the workpiece contact plane of the spring element, in the installed condition, is not at an axial spacing from the screw element.

The spring element can be a ring which is in concentric relationship with the screw axis and which has a workpiece contact means which is of an annular configuration throughout. A progressive spring characteristic is then afforded by virtue of the fact that not only axial forces but also tangential ring forces are produced in the spring element when the screw connection is made.

The tangential forces are markedly lower if as an alternative the spring element comprises a plurality of radial, claw-like projections which each have at least a portion of the workpiece contact means. The way in which the force increases in dependence on the spring travel then depends not least on the radial extent of the spring element portions which are between the projections. In the case of screw connections involving relatively delicate workpieces, it can be a matter of considerable advantage if the spring element has a relatively flat spring characteristic so that, without excessively high tightening forces when making the screw connection, relatively great changes in length, especially on the part of the connected workpieces, only result in a relatively small loss of prestressing force in the screw connection.

In accordance with a development of the invention, not least by virtue of the fact that the spring element projects radially beyond the screw element, a lower level of hardness can be imparted to the spring element than to the screw element, for example by selective heat treatment. Other differences in the properties on the one hand of the screw element and on the other hand of the spring element can also be relatively easily achieved in spite of the integral nature of the components, as a consequence of the spatial differences involved in manufacture of the screw element.

Insofar as the screw element involves a screw it can be of a screwthread-forming and optionally self-boring nature.

The design configuration of the spring element, in accordance with the invention, also permits a screw connection between two workpieces of which at least one is a metal plate or a plastic element, in such a way that only the spring element and it bear with a predetermined prestressing force against the adjoining workpiece.

The drawing illustrates embodiments of the invention. In the drawing:

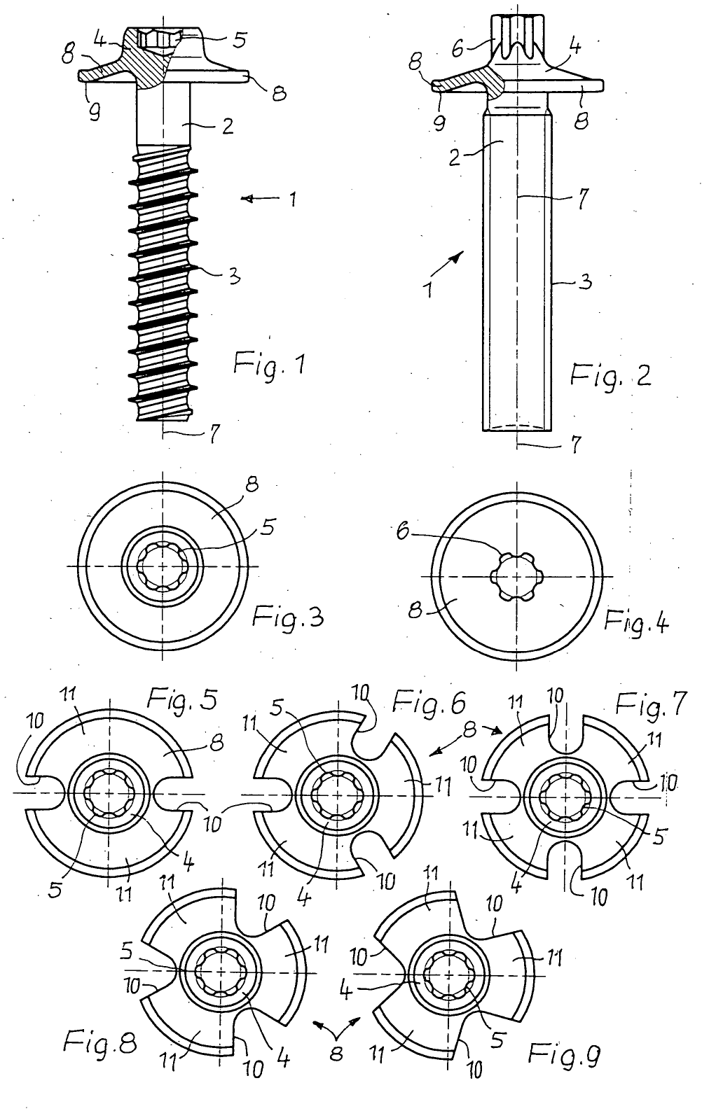

FIG. 1 is a partly sectional side view of a screw according to the invention with an internal tool engagement means in the head,

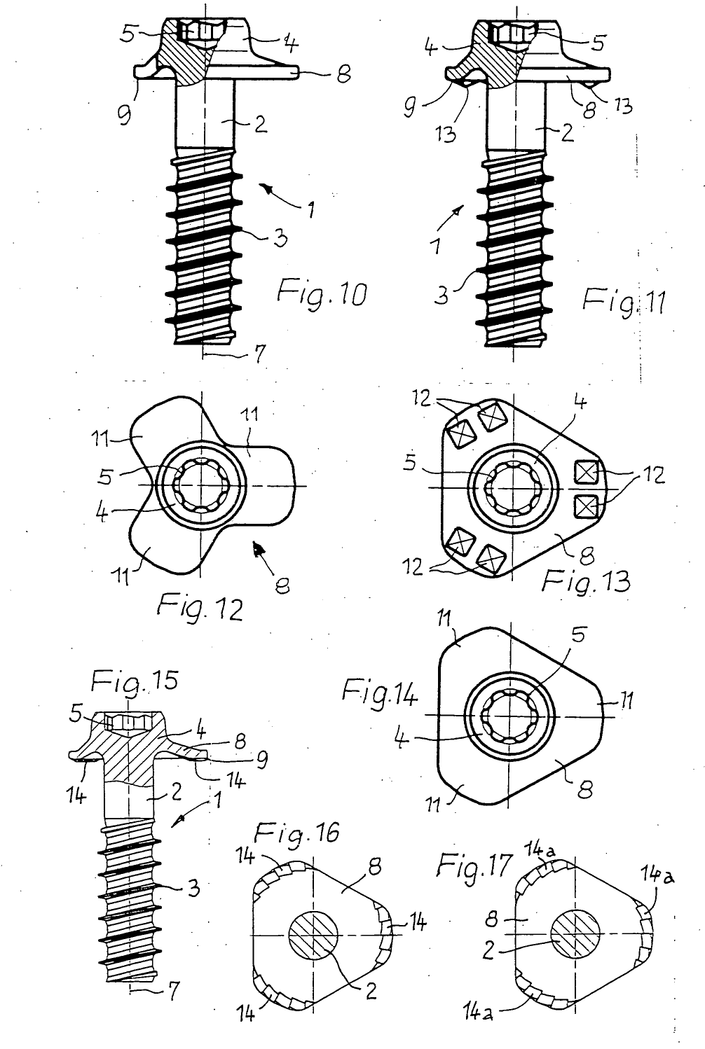

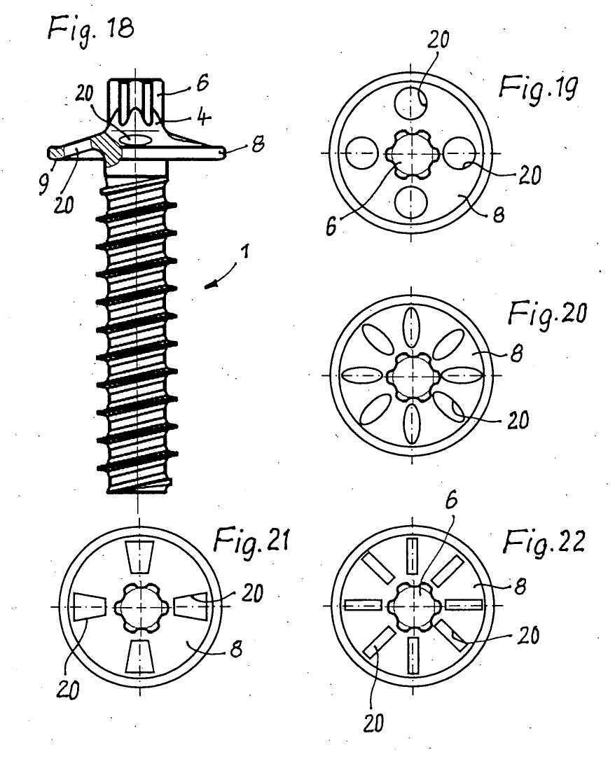

FIG. 2 shows a view corresponding to FIG. 1 of a substantially identical screw but with an external tool engagement means on the head,

FIG. 3 shows a plan view of the screw in FIG. 1,

FIG. 4 shows a plan view of the screw in FIG. 2,

FIGS. 5 through 9 are plan views corresponding to FIG. 3 of a screw as shown in FIG. 1 with modified spring elements,

FIGS. 10 and 11 are views as shown in FIG. 1 of screws with further modified spring elements,

FIG. 12 is a view of the screw shown in FIG. 10 from above,

FIG. 13 is a view of the screw shown in FIG. 11 from above,

FIG. 14 is a view corresponding to FIG. 13 of a modified spring element,

FIG. 15 shows a view as illustrated in FIG. 1 with a spring element modified similarly to FIG. 13,

FIGS. 16 and 17 show views of the spring element of FIG. 15 from below,

FIG. 18 shows a view corresponding to FIG. 2 of a screw with an altered spring element, and

FIGS. 19 through 22 are plan views of the screw of FIG. 18 with different configurations of its spring element.

All screws 1 have a shank 2 and a screwthread 3 as well as a head 4. The tool engagement means required for making the screw connection is an internal engagement means or recess 5 in the case of the screws shown in FIGS. 1, 10, 11 and 15, but it is in the form of an external engagement means 6 in the case of the screw shown in FIG. 2 (in which the screwthread 3 is not shown). The choice between an internal engagement means or an external engagement means is of no significance for the invention. Moreover, the screw element may also involve a screw nut.

In all cases a spring element 8 is integrally connected to the head 4 (or a screw nut) and projects beyond it radially with respect to the axis 7. In addition the workpiece contact surface 9 which in the cases of the screws 1 shown in FIGS. 1 through 4 is annular is at a certain spacing from the head 4 in the direction of the axis 7. The configuration of the contact means 9 makes it possible to vary the spring characteristic of the spring element 8 and the pressure in relation to surface area when tightening the screw connection, in relatively wide limits, depending on the respective requirements of the screw connection.

As stated, in the embodiments of the spring element 8 which are shown in FIGS. 3 and 4, the workpiece contact means 9 of the spring element 8 is annular so that, when the screw connection is tightened and thus the spring element 8 is resiliently deflected parallel to the axis, the increase in the peripheral dimension which that involves produces a peripheral stress in the spring element 8, and that peripheral stress reinforces the spring characteristic. That peripheral stress is lower if, as shown in FIGS. 5 through 9, the spring element 8 is interrupted by radial incisions 10 so that the spring element 8 comprises a plurality of radial, claw-like projections 11 which each have only a portion of the workpiece contact means 9. In the cases shown in FIGS. 5 through 7, these involve substantially U-shaped incisions 10, more specifically two incisions (FIG. 5), three incisions (FIG. 6) and four incisions (FIG. 7) so that accordingly there are two, three and four projections 11 respectively.

The spring elements 8 as shown in FIGS. 8 and 9 differ from the embodiment of FIG. 6 in that the incisions 10 are not U-shaped but involve a pointed or right-angled configuration, whereby the portion of the workpiece contact means of each projection 11 is correspondingly reduced.

While the spring elements 8 of the embodiments illustrated in FIGS. 3 through 9 involve the basic shape of a circle, this does not apply to the embodiments of FIGS. 10 through 14. Rather, in that case, a stamping-out operation (deburring) or suitable control in the shaping procedure provides spring elements 8 with projections 11 of a rounded rectangular configuration in the case of the embodiment shown in FIGS. 10 and 12, while in the case of FIGS. 11, 13 and 14 the spring elements 8 produced are of a basic shape which is of a rounded triangular configuration. It is apparent that the spring characteristic of the spring elements 8 shown in FIGS. 13 and 14, in relation to that of the spring element 8 shown in FIG. 12, is also steeper, even if less so, than that of the spring elements 8 shown in FIGS. 3 and 4 in relation to those of the spring elements 8 in FIGS. 5 through 9.

In the case of the spring element 8 shown in FIG. 13, the drawing shows that diamond-shaped impressions 12 into the spring element 8, in the region of the workpiece contact means 9, produce projections 13 (FIG. 11) which provide for positively locking clamping engagement of the spring element 8 in the adjoining workpiece when the screw connection is made.

FIGS. 15 through 17 show a different profiling of the contact surface (workpiece contact surface 9) of the spring element 8, which profiling can also serve for scratching off a paint or other coating on the workpiece, for securing electrical contact (for example grounding) or for locking the screw connection to prevent it from coming loose. For the right-hand thread shown in FIG. 15 the tooth arrangement 14 is a locking tooth arrangement (FIG. 16) and the tooth arrangement 14a in FIG. 17 is a friction tooth arrangement.

The spring element 8 of the screw 1 shown in FIG. 18 basically corresponds to the screw illustrated in FIG. 2. It has the same annular workpiece contact means 9, but the annular region of the spring element 8, which is between the workpiece contact means 9 and the head 4 of the screw, has openings therethrough, whereby the spring characteristic thereof is altered. The openings 20 which are distributed uniformly over the periphery of the annular region can be of different configurations, in particular round (FIGS. 19 and 20) or of a cornered configuration, and can be produced for example by stamping out (prior to a concluding heat treatment).

1. A screw element with a tool engagement means and a spring element which is formed on the screw element in one piece in coaxial relationship with the screw axis and which with its free edge defines a workpiece contact plane which is perpendicular to the screw axis and which is at an axial spacing from the screw element, wherein the spring elements is mounted at the periphery of the screw element, that is to say a screw head or a screw nut, it projects radially beyond the periphery and it forms a workpiece contact means which is disposed outside the periphery and which is in concentric relationship with the screw axis.

2. A screw element as set forth in claim 1, wherein the spring element is a ring which is concentric with respect to the screw axis and which has a workpiece contact means which is annular throughout.

3. A screw element as set forth in claim 2, wherein the ring forming the spring element has a plurality of openings distributed uniformly over its periphery.

4. A screw element as set forth in claim 1, wherein the spring element comprises a plurality of radial, claw-like projections which each have at least a respective portion of the workpiece contact means.

5. A screw element as set forth in claim 4, wherein three projections are arranged distributed uniformly at the periphery of the screw element.

6. A screw element as set forth in claim 5, wherein the spring element has a relatively flat spring characteristic.

7. A screw element as set forth in claim 6, wherein the spring element is of lower hardness than the screw element.

8. A screw element as set forth in claim 7, wherein the spring element has projections in the region of the workpiece contact means.

9. A screw having a head in the form of the screw element as set forth in claim 8, wherein it is of a thread-forming and optionally self-boring nature.

10. A screw connection between two workpieces of which at least one is a metal plate or a plastic element, with a screw element as set forth in claim 9, wherein only the spring element and it bears with a predetermined prestressing force against the adjoining workpiece.
